(19) United States
(12) Patent Application Publication
(10) Pub. No.: US 2002/0077905 A1
(43) Pub. Date: Jun. 20, 2002

(54) Integrated system for differentiation and positioning of a commercial offering

(75) Inventors: Craig M. Arndt, San Jose, CA (US); Tianning Xu, San Antonio, TX (US); David M. Tumey, San Antonio, TX (US); Richard C. Vogel, San Antonio, TX (US)

Correspondence Address: WAYNE J. COLTON, INC., The Milam Building Suite 1032, 115 East Travis Street, San Antonio, TX, 78205, US

(73) Assignee: TVX Internet Services, Inc., San Antonio, TX (US)

(21) Appl. No.: 09/927,262

(22) Filed: Aug. 10, 2001

Related U.S. Application Data
(63) Continuation-in-part of application No. 09/638,059, filed on Aug. 11, 2000.

(51) Int. Cl. G06F 17/60

(52) U.S. Cl. 705/14

(57) ABSTRACT

A response to an advertisement driven stimulus is effected by locating a portable device at a terrestrial position at a point in time; identifying a fixed point advertisement in proximity to the portable device based upon the device's terrestrial position; and providing a response specific to the fixed point advertisement. The point in time is determined by activation of a switch associated with the portable device, whereafter the device is located by receiving a navigational signal. Communication is automatically established with a central data server where the fixed point advertisement is identified by comparing the terrestrial position of the portable device with a plurality of tabulated positions of fixed point advertisements. A unique identifier within the portable device and the position of the portable device are utilized by the data server to tailor a specific response to the advertisement based stimulus.

### RELATED APPLICATION

The present application is a continuation-in-part of U.S. patent application Ser. No. 09/638,059 filed Aug. 11, 2000. By this reference, the full disclosure, including the claims and drawings, of U.S. patent application Ser. No. 09/638,059 is incorporated herein as though now set forth in its entirety.

### FIELD OF THE INVENTION

The present invention relates to electronic commerce. More particularly, the invention relates to an integrated system for acting upon a consumer's purchase impulse utilizing a unique combination of navigational satellite or other automated positioning systems, wireless communications, the public switched telephone system or other substantially equivalent communication system, the Internet and existing commercial delivery services.

### BACKGROUND OF THE INVENTION

According to government statistics, drivers on the United States' streets and highways accrue over 2.7 trillion vehicle miles per year. Worldwide, this equates to an inestimable amount of time spent in the automobile each day by members of the consuming public. Advertisers, however, have not overlooked these staggering statistics. For example, in the United States alone, the top five billboard companies own an estimated 575,000 roadside signs. Recognizing the opportunities offered by modern technology, the represented advertisers typically include telephone contact information and Internet web page or electronic mail addresses in addition to physical directions to an outlet for the advertised goods or services. In this manner, consumers are better able to make use of their drive time for gaining product information or even consummating the purchase of a desired product or service.

Notwithstanding advertisers' heightened efforts to reach the millions of cellular telephone equipped, Internet savvy consumers driving past roadside signs, billboard advertising still suffers relative disadvantages. Most obvious among the disadvantages is the necessity to remove significant attention from the driving task, often during the rush hours, to write down Internet addresses or telephone numbers and/or to place a cellular telephone call. Additionally, in the case of the more careful driver who chooses to follow-up on the purchase impulse after safely arriving at a fixed destination, the advertiser is at risk that that the driver will lose the purchase impulse due to passage of time or will forget the necessary contact information. Finally, while the Internet provides an increasingly popular channel for access to information without the fear of high pressure sales inherent to telephone calls or visits to a dealer in the advertised goods or services, very few drivers have access to an Internet connection during the commute. Further, it is at least debatable whether such access is even desirable in light of our present feelings for the impact that that the cellular telephone may have had on traffic safety.

It is therefore an overriding object of the present invention to improve over the prior art by providing a method and apparatus by which the commercial impact of roadside advertising may be dramatically increased without compromise of highway safety. It is a further object of the present invention to provide such a method and apparatus that is also extendable to other advertising opportunities such as, for example, television or radio broadcast advertising. It is yet another object of the present invention to provide such a method and apparatus that is simple to implement, requiring no significant initial investment by the advertiser and that requires minimal or no intervention by the service provider for change of advertising content. Finally, it is an object of the present invention to provide such a method and apparatus wherein the consumer may be spared the hardware costs associated with implementation, all such costs being distributed among those advertisers that actually benefit from the service and recovered from those advertisers by the service provider at the time the benefit is conferred.

### SUMMARY OF THE INVENTION

In accordance with the foregoing objects, the present invention—a method for providing a response to an advertisement driven stimulus—generally comprises locating a portable device at a terrestrial position at a point in time; identifying a fixed point advertisement in proximity to the portable device based upon the device's terrestrial position; and providing a response specific to the fixed point advertisement. The point in time is determined by activation of a switch associated with the portable device, such as a “click” button provided thereon. The device is located by receiving a navigational signal, such as that provided by the Global Positioning System (GPS). To this end, the portable device comprises a GPS receiver.

The fixed point advertisement is identified by comparing the terrestrial position of the portable device with a plurality of tabulated positions of fixed point advertisements. The tabulated positions are maintained in a central database on a localized data server with which the portable device is adapted to remotely communicate. This communication may be by any wireless data transmission system, but preferably is through the public switched telephone network as accessed by a cellular telephone integral with the portable device. In order to achieve maximum benefit from the present invention, the communication should be automatically initiated upon activation of the switch associated with the portable device. This communication, however, may follow a delay at the operator's option.

Because the portable device comprises a unique identifier, the response may be tailored not only to the identified fixed point advertisement but also to the portable device with which the advertisement is identified. To this end, one response comprises transmitting an electronic message to a predetermined address, the content of the electronic message being determined by the identification of the fixed point advertisement and the predetermined address being determined by the unique identifier. Similarly, another response comprises transmitting an electronic message to a predetermined address, the content of the electronic message being determined by the unique identifier and the predetermined address being determined by the identification of the fixed point advertisement. Finally, although many other responses are contemplated within the scope of the present invention, the response may also comprise paying for goods or services, the goods or services being determined by the identification of the fixed point advertisement and payment being based upon the unique identifier.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a functional block diagram, the preferred embodiment of the integrated system for differentiation and positioning of a commercial offering as implemented according to the present invention and, in particular, shows the interfaces between the user side and the processing side thereof;

FIG. 2 shows, in a functional block diagram, details of the implementation of the preferred embodiment for the processing side of the system of FIG. 1;

FIG. 3 shows, in a functional block diagram, details of a first configuration for the preferred embodiment of the user side of the system of FIG. 1;

FIG. 4 shows, in a functional block diagram, details of a second configuration for the preferred embodiment of the user side of the system of FIG. 1;

FIG. 5 shows, in a functional block diagram, details of a third configuration for the preferred embodiment of the user side of the system of FIG. 1;

FIG. 6 shows, in a functional block diagram, details of a fourth configuration for the preferred embodiment of the user side of the system of FIG. 1;

FIG. 7 shows, in a functional block diagram, details of a fifth configuration for the preferred embodiment of the user side of the system of FIG. 1;

FIG. 8 shows, in a functional block diagram, details of a sixth configuration for the preferred embodiment of the user side of the system of FIG. 1;

FIG. 9 shows, in flowchart, an overview of the preferred method of operation of the system of FIG. 1;

FIG. 10 shows, in flowchart, details of the resolve target location step of the process shown in FIG. 9;

FIG. 11 shows, in flowchart, details of the provide service step of the process shown in FIG. 9;

FIG. 12 shows, in flowchart, details of the advertiser's account setup and maintenance functions of the system of FIG. 1;

FIG. 13 shows, in flowchart, details of the user's account setup and maintenance functions of the system of FIG. 1;

FIG. 14 shows, in a functional block diagram, details of an extension of the concepts embodied by the present invention; and

FIG. 15 shows, in flowchart, details of a further extension of the concepts embodied by the present invention.

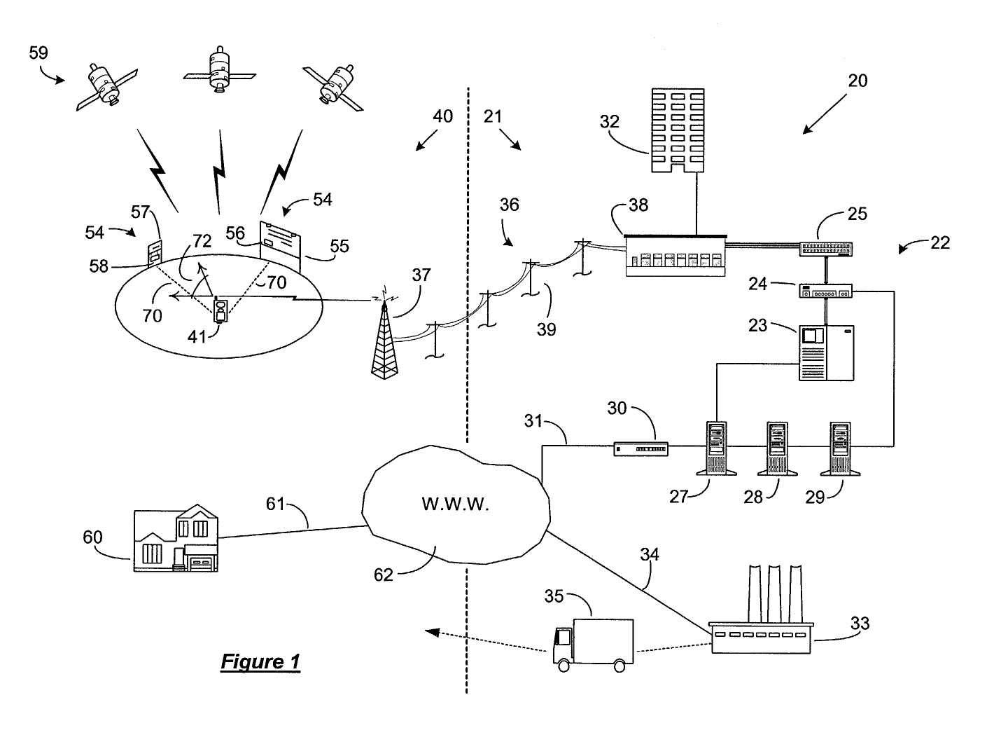

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

Referring now to the Figures, an integrated system for differentiation and positioning of a commercial offering 20 is shown to generally comprise a user side 40 for collection of a user's commercial intentions and a processing side 21 for acting upon those intentions. The user side 40 is preferably linked to the processing side 21 through the public switched telephone network 36. As will be better understood further herein, the user's location is captured by pressing a “click” button 48 on a location capture unit 41 when the user desires more information about a product advertised on a closely located fixed position advertisement 54. This location information is then transmitted through the public switched telephone network 36 to the processing side 21 where an information center 22 may interpret and act upon the user's desire. As also will be better understood further herein, the user may also be connected by wireless telephone 42 to a business telephone call center 32; order a product from a manufacturer's distribution center 33; or participate in an interactive, prompt-based cellular telephone call with the information center 22.

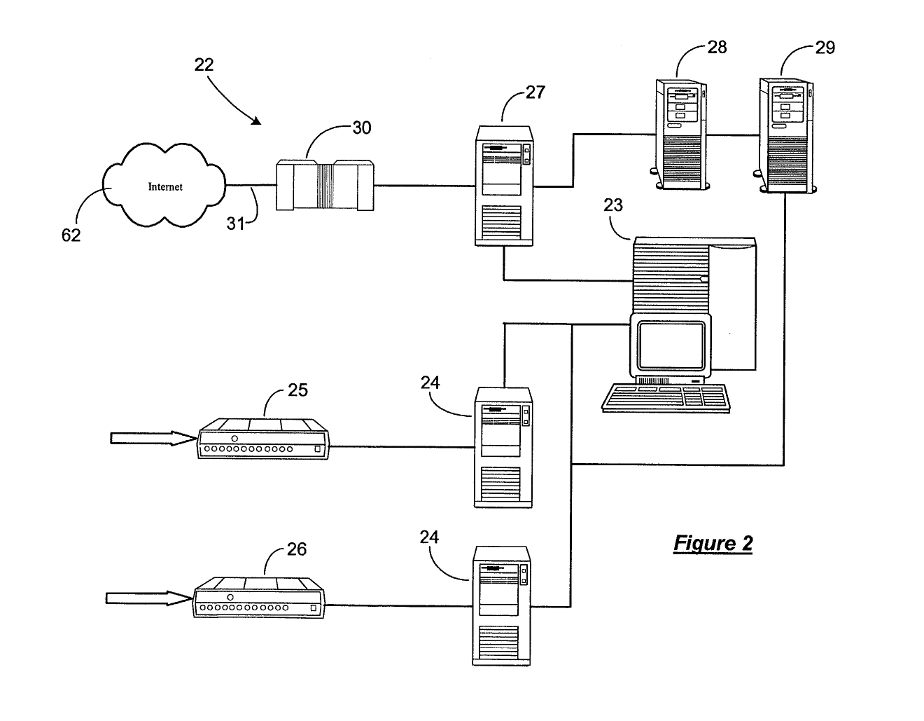

As shown particularly in FIG. 2, the information center 22 generally comprises a data server 23 in communication with the public switched telephone network 36 through one or more automated answering units 24 and in communication with users and/or advertising clients through a connection 31 to the Internet 62. In the preferred embodiment of the present invention, an automated answering unit 24 is adapted to receive calls from a multi-port voice modem 25 and/or a digital interface 26 to the public switched telephone network 36. As will be better understood further herein, when a user depresses the “click” button 48 on a location capture unit 41 a wireless or other telephone communication is initiated with the information center 22 through, for example, a cellular cell site 37 connected to a dial central office 38 over telephone land lines 39. This communication is then answered by the automated answering unit 24 through the multi-port voice modem 25 or digital interface 26. Collected information is then processed upon the data server 23 as detailed further herein. In most cases, this processing will result in the transmission of an electronic mail message through the Internet 62. In the preferred embodiment of the present invention, connectivity to the Internet 62 is maintained by a web server 27 through a fire-walled router 30. A separate electronic mail server 28 is provided in communication with the web server 27 in order to distribute processing load. Likewise, because the electronic mail may often comprise multi-media components, a separate multi-media server 29 is preferably provided in communication with the electronic mail server 28.

As shown in FIGS. 3 through 8, the location capture unit 41 of the present invention may take any of a number of configurations, the only critical requirement being that the location capture unit 41 be able to accurately determine the user's position and, thereafter, transmit the position information to the information center 22. As shown in FIG. 3, one such configuration may comprise a wireless telephone 42, which may be of the cellular, satellite, radio or other variety, linked with a global positioning satellite system (“GPS”) receiver 49. A data capture unit 47, which may be co-located with the GPS receiver 49, acquires and stores the user's position data, as determined from a transmitting navigational satellite system 59, when the “click” button 48 is depressed. As will be better understood further herein, the data capture unit 47 may also comprise an interface to a directional indicator 52, such as a flux gate compass 53, for provision of orientation information to the information center 22. Finally, each configuration of the location capture unit 41 may be provided with an optional headset 50 for enhanced safety during use of the present invention.

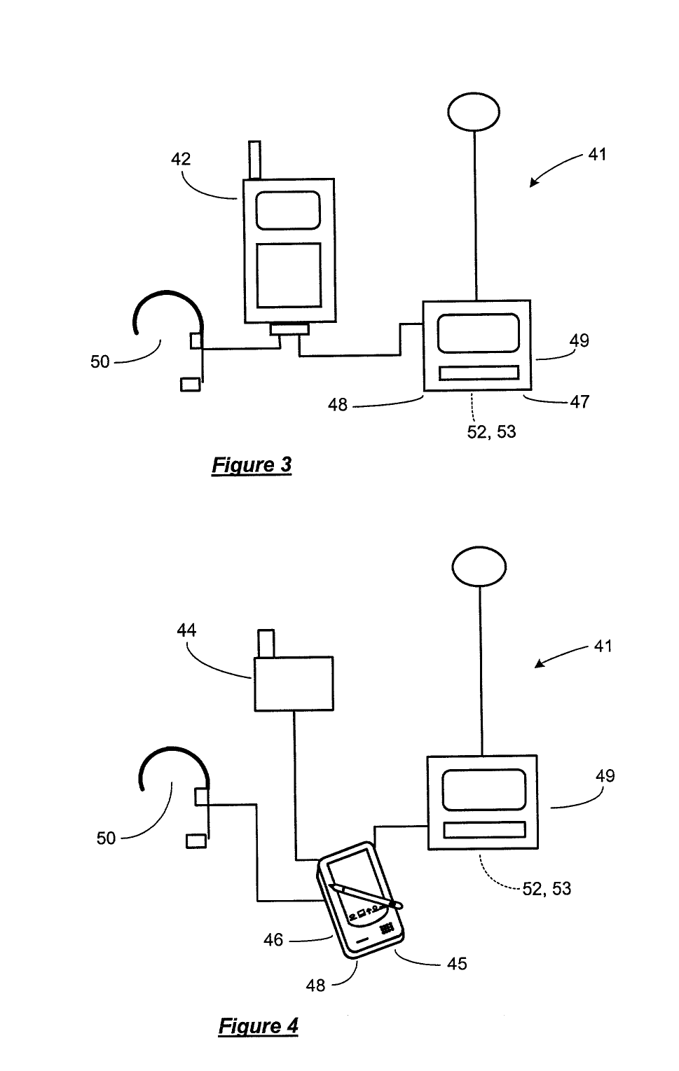

In the configuration of FIG. 4, the location capture unit 41 is shown to comprise a wireless modem 44 and portable computer 45, such as a handheld computing device 46, in place of the wireless telephone 42. On the other hand, a handheld computing device 46 may be utilized to take advantage of a user's existing wireless telephone 42 and GPS receiver 49, such as are each now commonly installed as part of a vehicle's built-in communications and navigation systems. In this case, an interface port may be provided whereby the infrared or wireless short range communications capability, as presently implemented in many handheld computing devices 46, may be utilized to establish communication between the wireless telephone 42 and GPS receiver 49 and the handheld computing device 46. As will be recognized by those of ordinary skill in the art, the necessary software for implementation of the present invention may reside entirely within the handheld computing device 46 or may be distributed between the handheld computing device 46 and the interface port. Finally, the interface port also preferably comprises a holder for the handheld computing device 46, thereby facilitating access to the system while driving or engaging in similar activity. Finally, it is noted that the handheld computing device may comprise such a device as of these commercially available under the trademark “PALM.” Those of ordinary skill in the art will recognize, however, that other substantially equivalent devices are also presently commercially available and appropriate for implementation of many of the features of the present invention.

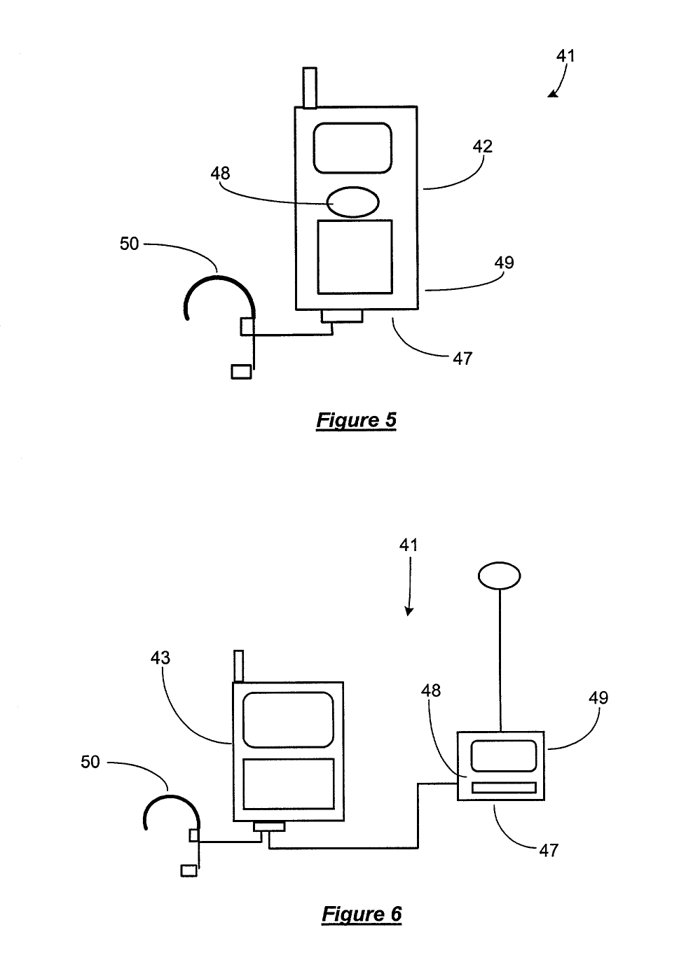

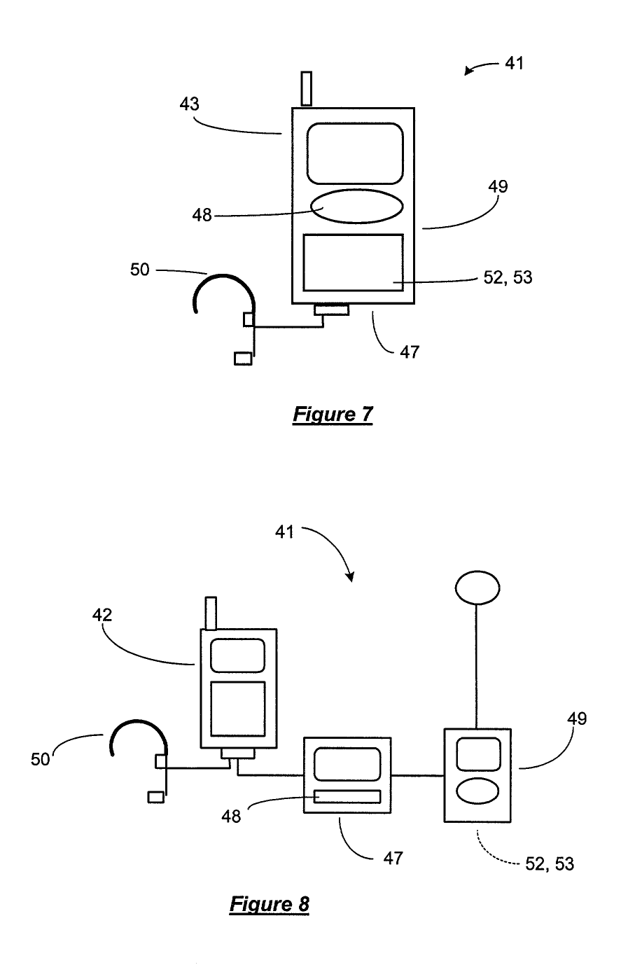

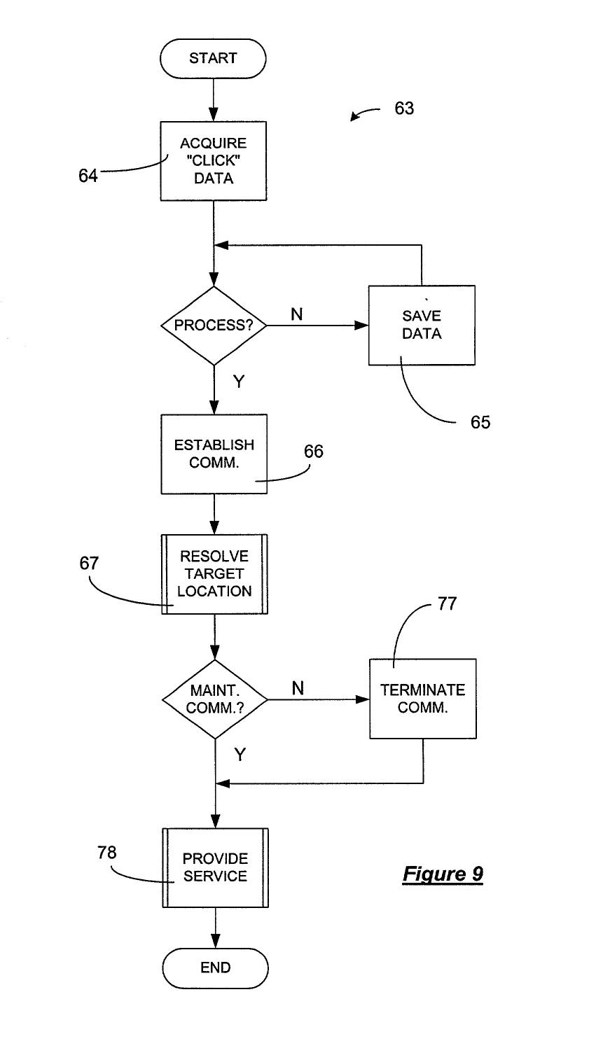

As particularly shown in FIG. 5, the various components of the location capture unit 41 may also be provided within a highly integrated wireless telephone 42 of FIG. 5 having a GPS receiver 49 and data capture unit 47 located therein. As shown in FIG. 6, the wireless telephone 42 may also be replaced with a web browser capable wireless telephone 43. Likewise, the web browser capable wireless telephone 43 may be further integrated to include the GPS receiver 49 and data capture unit 47, as shown in FIG. 7. In yet another configuration, however, the data capture unit 47 may provide an interface between a standard wireless telephone 42 and an existing GPS receiver 49, such as may form a part of an existing in-dash automobile navigation system. This configuration is shown in FIG. 8. In any case, it is to be understood that the location capture unit 41 may combine any of the forgoing features as well as other features not specified so long as the unit 41 has the capability to collect user location information and to transmit the collected information to the information center 22.

Turning now to FIG. 9, the preferred method for operation 63 of the present invention is detailed. In the first step of operation 64, the user depresses the “click” button 48 on the location capture unit 41, which causes the acquisition of the user's present location from the GPS receiver 49. If the user's wireless telephone 42, or other communication device 44, is in use or if the user wishes to process the request at a later time, the acquired data is then saved 65 within the location capture unit 41. In any case, when the user is ready to process the request, communication is established 66 between the location capture unit 41 and the information center 22. Based upon the position data received, or other information as better understood further herein, the location of the intended target is then resolved 67. As will be better understood further herein, once the target location is uniquely resolved, communication between the location capture unit 41 and information center 22 may be terminated 77 unless necessary for the provision of the requested service. Finally, as shown in step 78, the requested service is provided to the user.

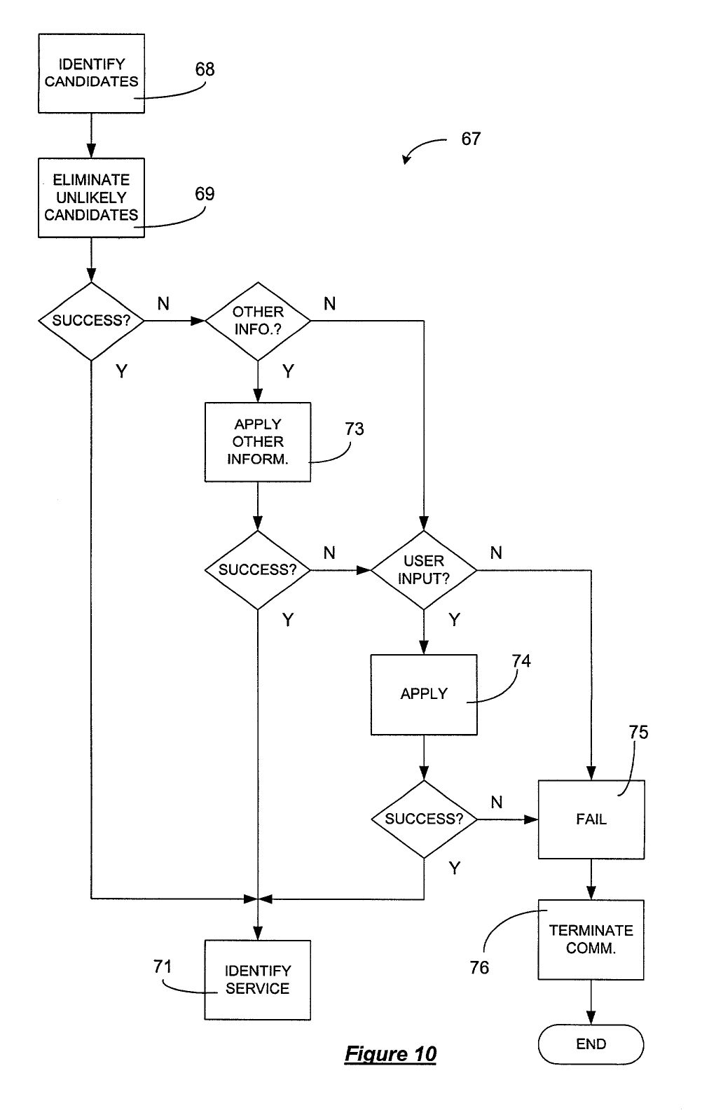

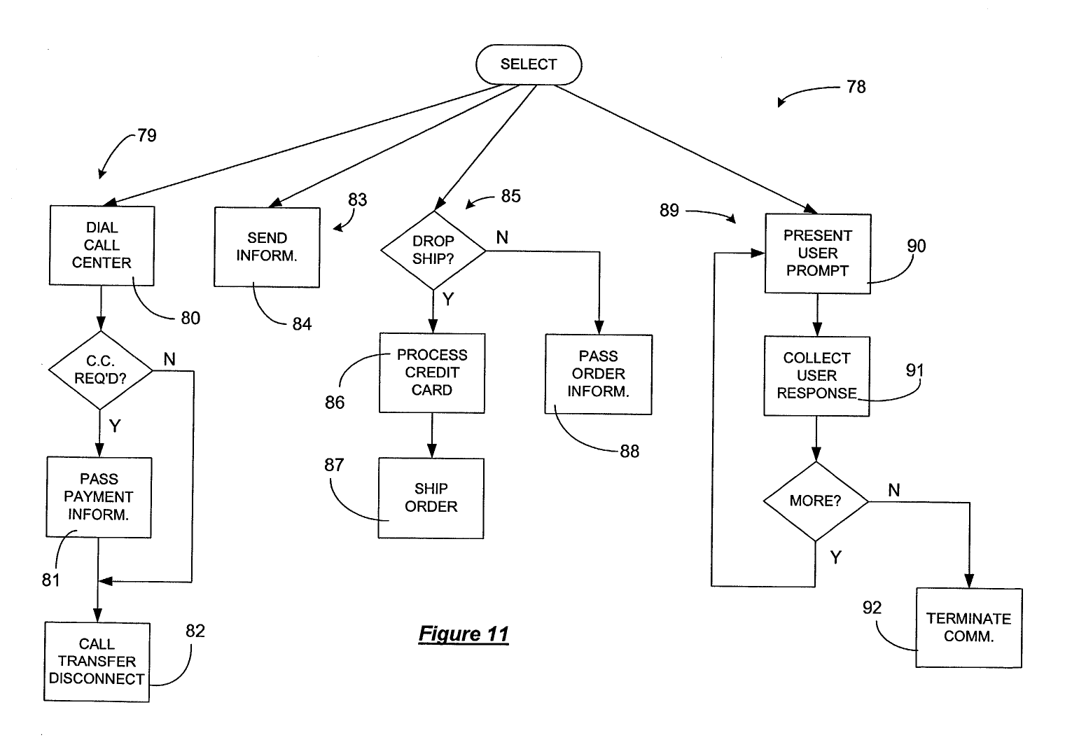

Although those of ordinary skill in the art will recognize many substantially equivalent alternatives, the preferred method for resolution of the target location is detailed in FIG. 10. As shown in FIG. 10, the first step 68 in resolution of the target is to identify the candidate targets based upon their location in relation to the position of the location capture unit 41 at the time the “click” button 48 was depressed. According to the preferred embodiment of the present invention, this is accomplished by translating the received location information to a zone on a global map. The possible candidates are then defined as all of the fixed position advertisements 54 within that zone or within neighboring zones. In the next step 69, unlikely candidates are eliminated based upon their relative distances from the location capture unit 41 at the time of the click. Although those of ordinary skill in the art will recognize that it would be possible to select the target location closest to the location capture unit 41, it is desirable to apply slightly more sophisticated processing in order to prevent resolution errors. In the preferred embodiment, candidates are only eliminated if they are at a much greater distance from the location capture unit 41 than is the likely candidate or candidates. Additionally, the threshold distance to be applied may vary with the type of fixed position advertisement 54. In this manner, the present invention accounts for the fact that a roadside sign 55, such as a large billboard with an incorporated “click” logo 56, may be visible at a much greater distance than would be a “For Sale” sign 57, with attached “click” logo 58.

If the resolution of the target is at this point successful, i.e., there is only one likely candidate remaining, then the type of service requested is identified at the data server 23. This identification may then be used to determine whether it is appropriate to terminate communication 77 between the information center 22 and the location capture unit 41, thereby minimizing per-call charges. If, on the other hand, the target resolution is not yet successful, i.e., there remains more than one candidate target, other collected information may then be used to further attempt resolution 73. For example if merely comparing the distances 70 to the candidate targets proves insufficient to identify the intended fixed position advertisement 54, the directional field of view 72, as obtained through the directional indicator 52, or the direction of travel, as determined by the GPS receiver 49, may be utilized to determine which fixed position advertisement 54 the user was likely to have been looking at while the “click” button 48 was depressed. Again, if the resolution is at this point successful, the type of service may be identified 71.

If at this point the target has not yet been successfully resolved, however, user input may be applied 74, if desired. By way of example, such user input may be gathered by transmitting a computer generated synthesized voice through the public switched telephone network 36 to the user's wireless telephone 42 with a request for more information. In this manner, the user may be prompted to respond, for example, by “pressing one” if “looking at a first candidate target” or by “pressing two” if “looking at a second candidate target”. The user's response may then be transmitted back through the user's wireless telephone 42 to the information center 22 where the instruction may then be carried out. If no user input is available, however, such as would be the case if communication was interrupted communication prior to successful target resolution, the system must at this point must fail 75. Upon failure, however, a communication may nonetheless still be transmitted through electronic mail or other equivalent means notifying the user that the request cannot yet be fulfilled. This transmission may also include instructions or choices for response whereby the request may ultimately be fulfilled. For example, the electronic mail may allow the user to reply to a selection of reply addresses in order to effect the user's intention. On the other hand, the information requested by the user may be pre-positioned upon the web server 27 in which case the user would be provided with a URL address for each likely candidate. Finally, in the event of a resolution failure, all open communications between the location capture unit 41 and the information center 22 are terminated 76 in order to prevent further percall charges.

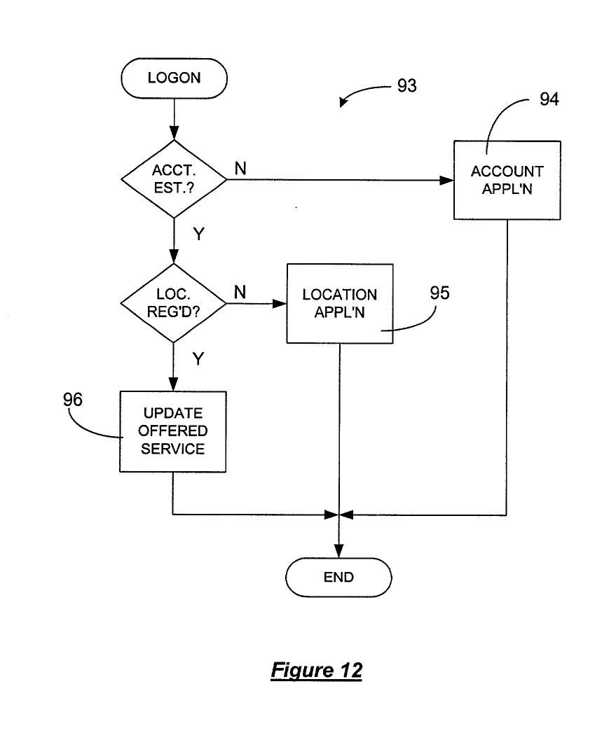

Turning now to FIG. 11, details of the various services that may be provided are shown. In one aspect of the present invention, clicking at a particular roadside sign 55 may indicate that the user wishes to be connected by wireless telephone 42 to a business call center 32 such as, for example, a hotel chain reservations line. The call pass through function 79 is then selected as the identified service and initiated by dialing 80 the call center 32. If payment information is required for completion of the call, such as would be the case if the user wished to be connected to a “900” telephone number or automatically make a hotel reservation or the like. For example, payment information is then passed 81 to the call center 32. In any case the service is completed by performing a call transfer disconnect 82, leaving the user connected in voice communication with the business call center 32. As will be apparent to those of ordinary skill in the art, if the service is identified as the call pass through routine 79, communication must not be terminated in step 77.

In many cases, it is envisioned that the user will simply desire information to be transmitted via electronic mail or otherwise to a business or residence 60. In this case, an information request 83 is fulfilled by simply transmitting 84 the desired information from the electronic mail server 28 through the Internet 62, allowing receipt by the user of the information at his or her residence 60 through his or her own Internet connection 61 without the necessity for actually talking with a sales person. In the case, for example, of a house for sale, this electronic mail may include multi-media components. In the exemplary case, a virtual tour of the home for sale may be generated on the multi-media server 29 and attached to the E-mail to be transmitted.

In another aspect of the information request 83, it may be that the user wishes to be contacted by the ultimate service provider or product manufacturer. In this case, the user's identity may be transmitted through the Internet 62 to the manufacturer 33 or service provider over their own Internet connection 34. The manufacturer 33 or service provider may then initiate contact with the user in any manner appropriate to the offered good or service and authorized by the user. For example, the user utilizing the present invention to contact a hotel or restaurant reservations clerk may wish that the hotel or restaurant contact the user by cellular telephone. In this manner, the user is spared cellular airtime charges until such time as a reservations clerk is available to actually speak with the user.

In yet another aspect of the present invention, it may be that the user desires to actually consummate a purchase 85 as a result of depressing the “click” button 48. Such a purchase request 85 may be fulfilled either by passing the order information to the manufacturer or by drop shipping. In the former case, the user's pertinent profile information, such as address and credit card number, are simply E-mailed to the manufacturer along with details of the product order. The manufacturer may then utilize any commercial delivery service 35 for fulfillment of the user's request. In the latter case, the user's credit card information may be processed 86 at the information center 22 whereafter the order can be shipped 87 without delay.

Finally, an interactive session may be established 89 with the user as a result of the “click.” In this case, the information center 22 provides the user with a series of synthesized voice prompts 90 and collects 91 responses entered into the user's telephone keypad or other available data input system. As with the call pass through function 79, the user interactive session 89 requires that the communication with the user be maintained until all responses are collected. At this time, however, the communication may then be terminated 92. In an alternate embodiment of the interactive session 89, the user may interface with the information center 22 through his or her web browser capable wireless telephone 43 or through his or her handheld computing device 46 and wireless MODEM 44 or through any other substantially equivalent mode of communication.

In an extension of the interactive session function 89 and the purchase request function 85, the present invention may be utilized to interactively consummate a purchase. For example, in one implementation of this feature, the principles of the present invention may be advantageously employed to enable a user to select and purchase a number of movie, or other, admission tickets, thereby bypassing long ticket booth lines. This is particularly advantageous when considering that delays incurred in line, which in fact may cause one to actually miss a show time, are likely caused by the volume of persons present who seek tickets to entirely different showings.

In operation, the user seeking tickets to a particular event simply moves to within the proximity of the ticket outlet and, thereafter, depresses the “click” button 48 on his or her location capture unit 41. The target event is then resolved, as previously described, and an interactive session 89 is established between the user and the information center 22. The user may thereby then select the particular event, the show time, the number of tickets required and the like and/or may provide information regarding special requirements such as for seniors' or children's tickets or disabled access or seating. As previously described, the user's interaction with the information center 22 may be through cellular or other wireless telephone 42, web browser capable wireless telephone 43, handheld computing device 46 and wireless MODEM 44 or any substantially equivalent mode of communication. In the case wherein the user decides that he or she does in fact wish to make a ticket or other purchase, pertinent profile information may be utilized to process the user's request as previously discussed.

It is noted that many readily available handheld computing devices 46 comprise an infrared or wireless communications link for short range transmission of data to and from the handheld computing device. As a result, although any of the previously mentioned devices may be utilized for the interactive session 89 between the user and the information center 22, short range communication capable handheld computing devices 46 may be utilized to additional advantage for this particular aspect of the present invention. In particular, an authorization code may, during the interactive session 89, be downloaded from the information center 22 to the user's handheld computing device 46. The handheld computing device 46 may then be taken with the user to the event venue and there utilized as an electronic ticket, thereby allowing the user to gain immediate access without stopping at a will call window or the like for identification and ticketing. Although the processing of the electronic ticket may be monitored, those of ordinary skill in the art will recognize many possibilities for implementation of this function though a completely automated and unattended system. In this manner, this aspect of the present invention is particularly adapted to ensure the fastest possible access to even the most crowded events, including not only movie theaters but also theme parks, concert events, sporting events and the like. Additionally, those of ordinary skill in the art will recognize that this aspect of the present invention may also be advantageously implemented in other applications such as, for example, streamlined passage through an automated car wash.

Turning now to FIG. 12, details of the advertiser's account setup and maintenance function 93 are provided. Upon logging-on to the system, it is first determined whether the advertising client has an account with the service provider. If not, the potential client is presented with an account application 94. The account application may be utilized by the service provider to determine what type of services, of those detailed in FIG. 11, the client may utilize. In the case of an established client, the system determines whether the fixed position advertisement 54 is registered. If not, a location application is presented 95. This location application may be utilized by the service provider to determine the location and orientation of the advertisement 54 for entry into the data server 23. Finally, in the case of an established location under the control of an established client, the advertiser may be presented with a screen for update of content specific information 96. In this manner, the advertising client may directly access the system 20 as advertising requirements change. For example, the client may upload a new file for transmission to any user that clicks on a particular controlled billboard 55 or in the case of a house for sale, for example, the client advertiser may change the asking price.

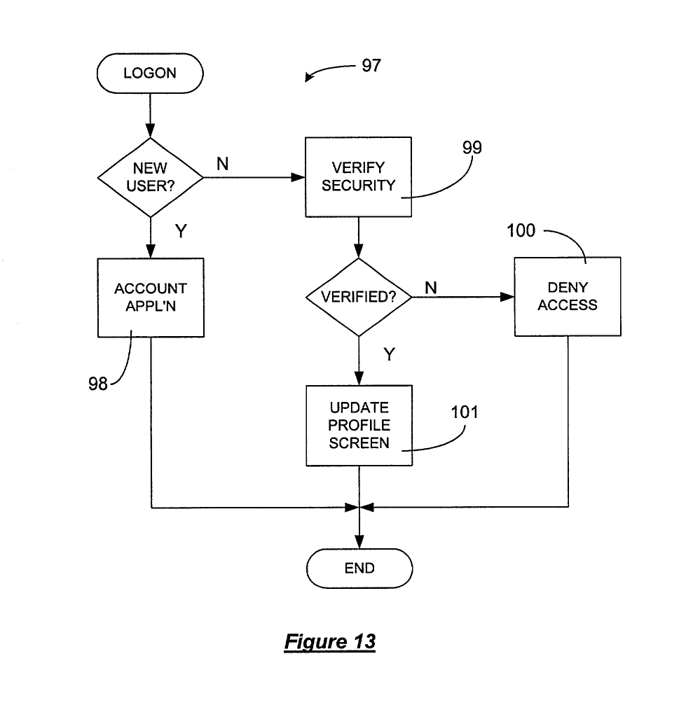

As shown in FIG. 13, the user's account setup and maintenance function 97 allows new users to provide billing and other preference information via an account application 98. Likewise existing users may access the system 20 to update this information 101. In the preferred embodiment of the present invention, however, a security step 99 is implemented to ensure that unauthorized users are denied access to others' accounts.

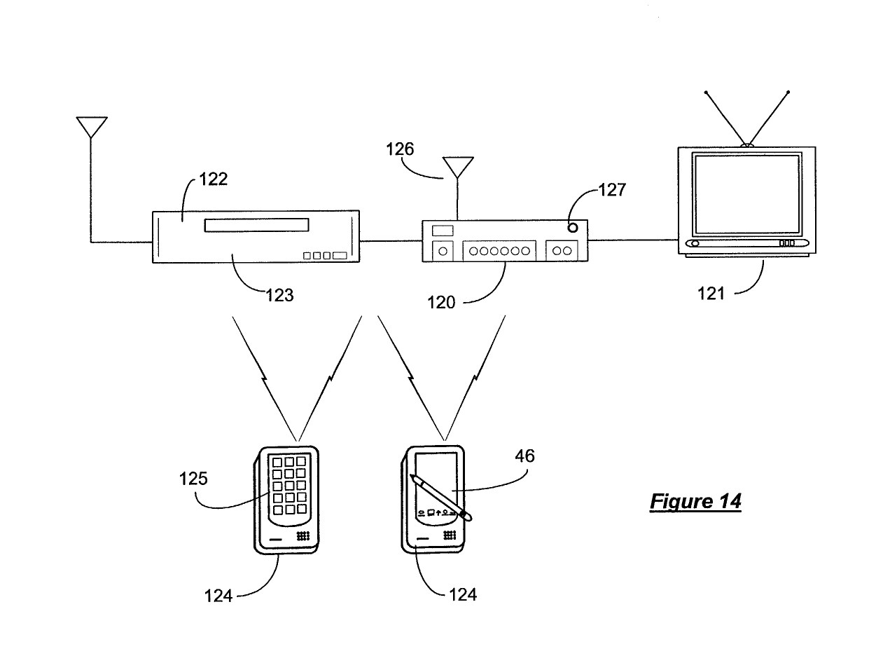

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, as shown in FIG. 14, the concepts of the present invention are readily extendible for enhanced effectiveness of television or radio advertisement. In the case of television advertisement, an unused line in the blanking interval of the NTSC, or other, video signal may be utlized to transmit advertiser information to a data capture unit 120 interposed the user's television 121 and tuning device 122, such as a VCR 123 or cable tuner. When the user wishes to respond to a “click logo” 56 displayed as part of the advertisement, he or she presses a click button 48 on a provided device 124 causing a signal to be transmitted to the data capture unit 120, which then stores the user's desire to take further action with respect to the advertisement tuned in at that time. While the provided device 124 may be specifically adapted for use with the television 121, such as a modified remote control device 125, those of ordinary skill in the art will recognize that the device 124 may also comprise the same location capture unit 41 utilized in other aspects of the present invention. For example, a personal computing device 46 with an infrared or wireless capability may be adapted to transmit the user's intention to the data capture unit 120 through a provided radio receiver 126 or infrared receiver 127.

In the case of radio advertisement, a specially modified radio may be provided in order that the data capture unit 120 may have available information as to what radio station the user is listening. Upon hearing an announcement to “click now,” the user may respond as previously described. In either the television or radio example, it is to be understood that the user side 40 may comprise any previously discussed combination of elements such that any previously discussed service may be provided. For example, the data capture unit 120 may be utilized as an automated telephone dialer for connection of the user with a call center 32, restaurant or hotel reservations line or the like. Finally, aspects of the present invention may be extended to a set of applications based upon a user-fee based business model. In particular, it is envisioned that the position location and communication aspects of the previously described embodiments may be implemented within a non-advertisement-based context, such as may exist in the provision of public goods. As one example of such an application, it is noted that the position location and communication aspects of the invention may be utilized to provide an automated tour guide for sight-seeing in the public parks or other recreation areas. In this case, the user may be directly charged (according to billing information in the user's profile) or the service may be provided as part of the admission fee to the park or like venue.

In a further extension of this model, it is also noted that the foregoing features of the invention may be implemented in order to provide landmark identification for the visually impaired or cognitively disabled persons. In particular, such a person may traverse a historical location and automatically (or upon “clicking”) receive audio information regarding the historical significance of his or her exact position within the location. With the use of a location capture unit 41 having directional capability (such as provided with a flux gate compass or the like), the user may receive additional or tailored information based upon the direction in which he or she is facing.

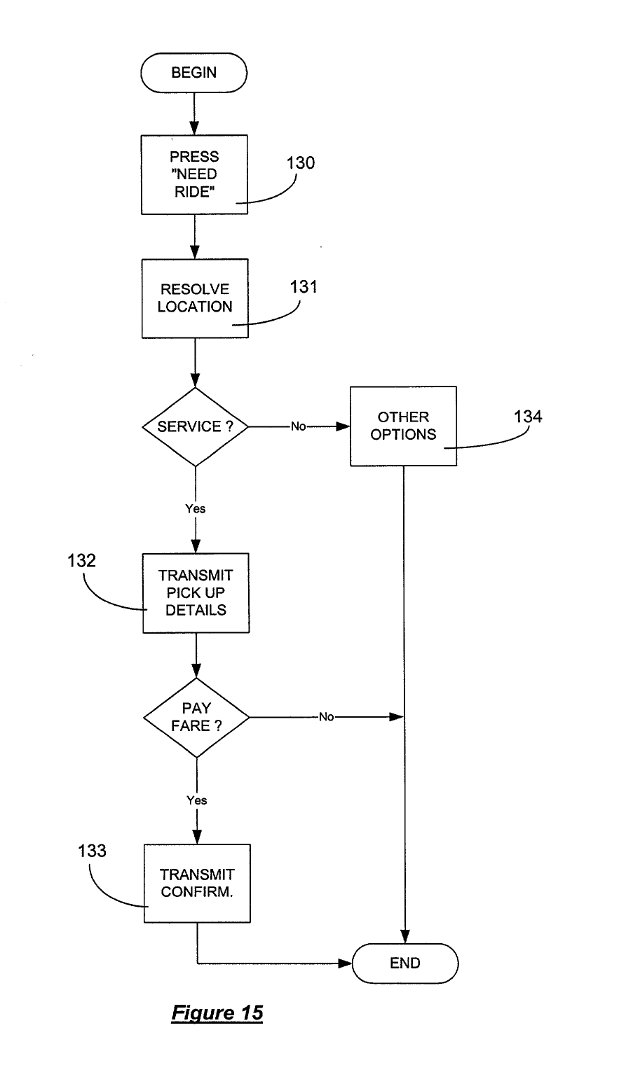

In yet a further extension of the present invention, provision may be made for a taxi cab or shuttle application, as shown in FIG. 15. In this application, the location caption unit 41 is preferably provided with a “need ride” button with a similar functionality to the previously described “click” button 48. As will be better understood further herein, however, those of ordinary skill in the art will also recognize that this application may be implemented utilizing a location capture unit 41 having only a “click” button 48. In any case, the user may utilize the location capture unit 41 to indicate his or her desire for service from a taxi or shuttle. Upon depressing 130 the appropriate button, the processing side 21 of the system 20 resolves 131 the user's location, substantially as described with respect to FIG. 9. In this case, however, either through the depression of a special “need ride” type button or through the solicitation of further input from the user, the system 20 of the present invention determines that the user requires taxi or shuttle service.

At this point, the processing side 21 determines whether such service is available based upon the user's resolved location. As will be understood by those of ordinary skill in the art, this determination may involve communication between the processing side 21 and the taxi or shuttle service in any of the manners previously described or the substantial equivalent thereof. Additionally, this determination may also be at least in part based upon system knowledge of the exact location and status (through the provision of GPS receivers within cabs or shuttles) of affiliated vehicles Should it be determined that the desired service is available, pickup details are transmitted 132 to both the user and the taxi or shuttle service. As will be understood by those of ordinary skill in the art, transmission to the transportation service may be through the service dispatcher or may be through direct communication with the driver or a terminal in the driver's vehicle. In any case, in the preferred embodiment of the present invention details regarding the identity of the user are transmitted to the driver and details regarding the service and driver are transmitted to the user. In this manner, the present invention betters upon the prior art inasmuch as the present invention provides heightened security for both the user in need of a ride and the driver called upon to provide the ride.

Additionally, the implementation of the present invention carries with it the additional benefit of enabling the user to automatically pay any required fare utilizing credit card or other financial information maintained upon the data server 23. In fact, it is envisioned that taxi or shuttle services taking advantage of the present invention may be able to entirely dispense with the necessity for carrying cash. To this end, the user is preferably given an option at the end of the ride to pay the fare utilizing the location unit 41. To pay the fare 133, the user need only depress an appropriate button on the location capture unit 41, whereafter authorization for the charge may be processed through the processing side 21. As will be understood by those of ordinary skill in the art, indication of the user's desire to pay the fair may be through direct communication between the location capture unit 41 and the processing side 21 or may be through a transmission between an appropriately configured location capture unit 41 and dashboard or otherwise mounted receiving equipment provided within the taxi or shuttle vehicle. Of course, tips may be added to the fare at this time at the user's discretion. Likewise, it is noted that should an appropriate service not be available, other option 134 such as voice connection 79 to a standard taxi service may be provided as previously described.

Finally, it will be apparent to those of ordinary skill in the art that this feature of the present invention can still be further extended to take advantage of the extraordinary communications connectivity provided through the network of the present invention For example, while the user is awaiting his or her taxi he or she may upload destination information to the processing side 21 through a handheld computing device 46 or the like. The information center 22 may then generate and transmit to the driver detailed directions for ensuring that the user is expeditiously delivered to his or her desired destination. In any case, because the scope of the present invention is much broader than any particular embodiment, the foregoing detailed description should not be construed as a limitation of the scope of the present invention, which is limited only by the claims appended hereto.

What is claimed is:

1. A method for providing access to a commercial establishment, said method comprising the steps of:
locating a portable device at a terrestrial position at a point in time;
identifying a commercial establishment in proximity to said portable device at said point in time based upon said terrestrial position; and
providing a response specific to said commercial establishment.

2. The method as recited in claim 1, wherein said locating step comprises receiving a navigational signal at said portable device.

3. The method as recited in claim 2, wherein said providing a response step comprises the step of paying for goods or services, said goods or services being determined by the identification of said commercial establishment.

4. The method as recited in claim 2, wherein said providing a response step comprises paying an admission fee.

5. The method as recited in claim 4, wherein said providing a response step further comprises generation within said portable device of an access code.

6. The method as recited in claim 5, wherein said portable device is adapted to communicate said access code to a receiver at said commercial establishment.

7. A method for utilizing a transportation service, said method comprising the steps of:
locating a portable device at a terrestrial position;
determining the availability of a transportation service based upon said terrestrial position; and
communicating said terrestrial position to said transportation service.

8. The method as recited in claim 7, wherein said locating step comprises receiving a navigational signal.

9. The method as recited in claim 8, said method further comprising the step of paying a service charge.

10. The method as recited in claim 9, wherein said service charge comprises a ride fare.
